(19) United States
(12) Patent Application Publication
(10) Pub. No.: US 2017/0070573 A1
(43) Pub. Date: Mar. 9, 2017

(54) COMMUNICATION DEVICE, COMMUNICATION SYSTEM, AND DATA PROCESSING DEVICE

(71) Applicant: HITACHI, LTD., Tokyo (JP)

(72) Inventors: Masayuki TAKASE, Tokyo (JP); Taisuke UETA, Tokyo (JP); Yuji OISHI, Tokyo (JP); Yasunari SHINOHARA, Tokyo (JP)

(73) Assignee: HITACHI, LTD., Tokyo (JP)

(21) Appl. No.: 15/190,697

(22) Filed: Jun. 23, 2016

(30) Foreign Application Priority Data
Sep. 3, 2015 (JP) 2015-174127

(51) Int. Cl. H04L 29/08; G06F 17/30

(52) U.S. Cl. CPC H04L 67/1097; G06F 17/30091; H04L 67/34

(57) ABSTRACT

A data processing device includes: an FPGA that includes a plurality of core circuits to which a data processing function is settable through a program file, and processes input data through the core circuits; an FPGA circuit file storage unit that stores the program file; and a control unit that sets the data processing function to the core circuits. In the data processing device, a request including information specifying the data processing function to be set and the core circuit is transmitted to a file management server, the data processing function is set based on a program file received in response to the request, and the received program file is stored in the FPGA circuit file storage unit.

### INCORPORATION BY REFERENCE

The present application claims priority from Japanese patent application No. 2015-174127, filed on Sep. 3, 2015, the entire contents of which are incorporated herein by reference.

### BACKGROUND

The present invention relates to a technique of changing a function and performance of a data processing system and processing data. Particularly, the present invention relates to a technique suitable for a technical field of a communication device, a communication system, and a communication method.

In recent years, various devices or services are connected via a network with the diversification of business or services using communication. In a carrier network of a related art, a dedicated network is constructed for each device or service. However, in the future, an improvement in a capability of a network and an abrupt increase in types of devices or services are expected, and thus it is required to integrate and accommodate various services.

When a plurality of communication services are accommodated, a processing function is allocated to a communication device according to a function of each communication service that accommodates them. Specifically, the communication device performs a process of analyzing information of an arrived packet, identifying a function (a protocol or the like), and transferring a packet to a packet processing circuit arranged for each function. In order to adapt to various services, it is necessary to cause a packet processing circuit to have various functions.

The application of a field-programmable gate array (FPGA) is considered in association with such a technique. The FPGA is known to be an integrated circuit whose configuration can be set by a purchaser or a designer after manufactured, and on-site programming is possible. In the FPGA, by performing the configuration according to a function to be implemented or the like, it is possible to rewrite all circuit setting information or rewrite some circuit setting information for each function. The FPGA is disclosed in the following related arts.

Patent Document 1 discloses a reconfiguration device capable of changing the number of circuits or types of circuits that can be changed in the FPGA.

Patent Document 2 discloses a technique of storing configuration data corresponding to a type of each FPGA in a centralized management device and transmitting configuration data corresponding to a type of FPGA in each node to the node of the FPGA.

Patent Document 1: Published Japanese Unexamined Patent Application 2014-071649 A

Patent Document 2: Published Japanese Unexamined Patent Application 2013-105463 A

### SUMMARY

The FPGA includes a plurality of divided regions (referred to as “core circuits”) and enables circuits of different functions to be set in the respective core circuits. At this time, although circuits of the same type (function) are set in FPGAs of the same type (the same product), if a core circuit is different, a program file (also referred to as “configuration data,” “circuit data,” or a “circuit file”) to be set is different.

As the number of service types increases, it is necessary to hold program files that correspond in number to a value obtained by multiplying the number (n) of core circuits included in the FPGA by the number (s) of service types in a file storage unit. In the technique disclosed in Patent Document 1, since the device holds the program files, it is necessary to store (n×s) program files, and thus the size of file storage unit of the FPGA is greatly increased. In addition, when the number of types of services or functions increases, the capacity of the file storage unit that is secured in advance is consumed, and thus there is a problem in that it is hard to store a program file for a new service.

In the technique disclosed in Patent Document 2, the program file corresponding to a type of FPGA in each node is transmitted from the centralized management device. It is possible to prepare the storage capacity for storing the program files in the centralized management device. However, when the number (T) of types (product types) of FPGAs increases, the number of program files applied to a predetermined core circuit of a predetermined node is increased in proportion to (T×n×s). Thus, there is a problem in that control as to a relation between data to be applied from the centralized management device and a core circuit to which data is applied is complicated.

The present invention was made in light of the above problems, and it is an object of the present invention to efficiently provide a desired circuit configuration suitable for a type of FPGA and a core circuit while suppressing an increase in a storage circuit capacity of a node.

In order to solve the above problems, one aspect of the present invention provides a communication system including a plurality of nodes and a file management server. Each of the nodes includes a plurality of packet processing modules to which a packet processing function is settable through a program file, and transmits a request including information specifying the packet processing function to be set and the packet processing module to the file management server, and sets the packet processing function based on information received in response to the request. The file management server includes a circuit storage database that holds a plurality of different program files which are settable to the packet processing module, and the file management server selects the program file based on the request, and transmits the selected program file to the node serving as a transmission source of the request.

As a specific configuration example of the present invention, the communication system further includes an operation management server that manages the plurality of nodes. The operation management server transmits an installation instruction including information specifying the packet processing function to be set to an arbitrary node among the plurality of nodes. The node includes a node resource management database that manages usage statuses of the plurality of packet processing modules, searches the node resource management database based on the installation instruction, selects the packet processing module to which the packet processing function is settable, and transmits the request including information specifying the selected packet processing module to the file management server.

Another aspect of the present invention provides a communication device including a field-programmable gate array (FPGA) that includes a plurality of core circuits to which a packet processing function is settable through a program file, and processes packets received from a network through the core circuits, an FPGA circuit file storage unit that stores the program file, and a control unit that sets the packet processing function to the core circuits. The communication device transmits a request including information specifying the packet processing function to be set and the core circuit to a file management server, sets the packet processing function based on a program file received in response to the request, and stores the received program file in the FPGA circuit file storage unit.

Another aspect of the present invention provides a data processing device including a field-programmable gate array (FPGA) that includes a plurality of core circuits to which a data processing function is settable through a program file, and processes input data through the core circuits, an FPGA circuit file storage unit that stores the program file, and a control unit that sets the data processing function to the core circuits. In the data processing device, a request including information specifying the data processing function to be set and the core circuit is transmitted to a file management server, the data processing function is set based on a program file received in response to the request, and the received program file is stored in the FPGA circuit file storage unit.

It is possible to efficiently provide a desired circuit configuration suitable for a type of FPGA and a core circuit while suppressing an increase in a storage circuit capacity of a node. Further, according to the present invention, even when data other than a communication packet is processed through an FPGA in a common server, it is possible to efficiently provide a desired circuit configuration suitable for a type of FPGA and a core circuit while suppressing an increase in a storage circuit capacity.

The details of one or more implementations of the subject matter described in the specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an overall configuration diagram of a system according to an embodiment;

FIG. 2 is a configuration block diagram illustrating an example of a multi-service node according to an embodiment;

FIG. 3 is a configuration block diagram illustrating another example of a multi-service node according to an embodiment;

FIG. 4 is a table illustrating an example of a node resource management database of a multi-service node according to an embodiment;

FIG. 5 is a table illustrating an example of a restoration database of a multi-service node according to an embodiment;

FIG. 6 is a configuration diagram illustrating an example of an FPGA circuit file storage unit of a multi-service node according to an embodiment;

FIG. 7 is a block diagram illustrating an example of an FPGA core circuit file management device according to an embodiment;

FIG. 8 is a configuration block diagram illustrating an example of a network operation management device according to an embodiment;

FIG. 9 is a table illustrating an example of a circuit storage database according to an embodiment;

FIG. 10 is a table illustrating an example of a resource management database according to an embodiment;

FIG. 11 is a table illustrating an example of a user management database according to an embodiment;

FIG. 12 is a flowchart illustrating an example of a circuit installation sequence according to an embodiment;

FIG. 13 is a flowchart illustrating an example of a circuit uninstallation sequence according to an embodiment; and

FIG. 14 is a flowchart illustrating an example of a device activation process according to an embodiment.

### DETAILED DESCRIPTION OF THE EMBODIMENTS

Hereinafter, exemplary embodiments will be described in detail with reference to the appended drawings. However, the present invention is not interpreted to be limited to description of the following embodiments. It would be understood by those having skill in the art that a specific configuration of the present invention can be made within a range not departing from a spirit or a gist of the present invention.

Notation such as “first,” “second,” and “third” in the present disclosure is added to identify constituent elements and not intended to limit a number or an order necessarily. Numbers for identifying constituent elements are used for each context, and a number used in one context does not necessarily indicate the same element in another context. A constituent element identified by a certain number is not prevented from doubling a function of a constituent element identified by another number.

For example, a position, a size, a shape, or a range of each of elements illustrated in the drawings may not be an actual position, an actual size, an actual shape, or an actual range thereof in order to facilitate understanding of the invention. Thus, the present invention is not necessarily limited to, for example, a position, a size, a shape, or a range illustrated in the drawings.

When there are a plurality of elements that can be regarded to be equivalent in an embodiment, a hyphen (-) or a number may be added to them to be distinguished. However, when it is unnecessary to distinguish them particularly, a hyphen (-) or a number may be omitted in order to avoid complexity.

In the present embodiment, a function such as a calculation or control is assumed to be implemented such that a processor executes a program stored in a storage device and performs a predetermined process in collaboration with other hardware. A program executed by a computer or the like or a means for implementing a function thereof may be referred to as a “function,” a “means,” a “portion,” a “module,” a “unit,” or the like.

### First Embodiment

A communication system according to an embodiment of the present invention will be described below.

<Communication System>

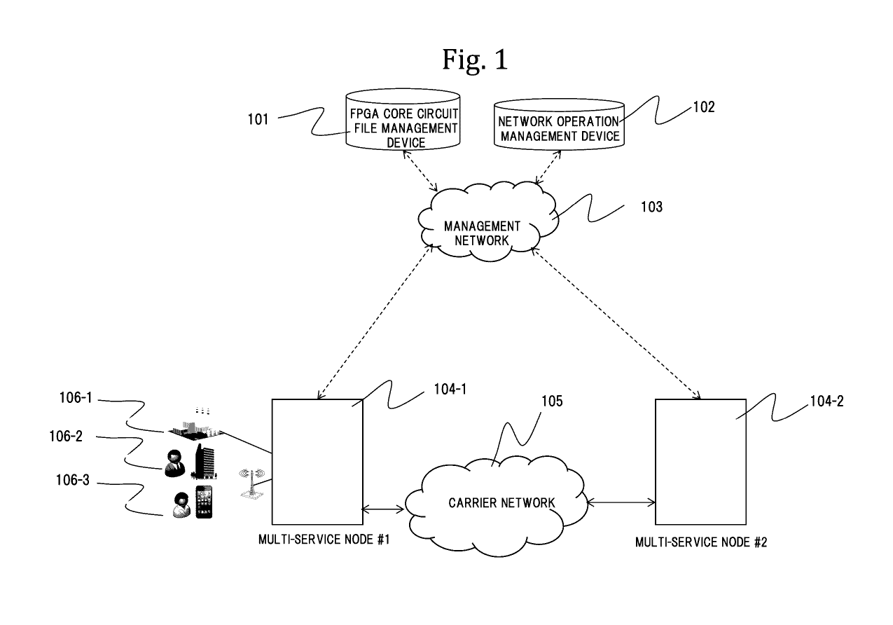

FIG. 1 is a block diagram illustrating an example of a communication system (network system) to which the present invention is applied. A communication system of FIG. 1 assumes that there are various attributes such as a social infrastructure 106-1, a company 106-2, and a general user 106-3 as a user. Various communication services for various users 106 are accommodated via a carrier network 105. In the carrier network 105, distributed packets are processed by multi-service nodes (communication devices) 104-1 to 104-n.

There are cases in which the multi-service node 104 has a different role such as an edge node or a core node, but in the present embodiment, it is not particularly distinguished. Each multi-service node 104 is not limited but connected to an FPGA core circuit file management device 101 and a network operation management device 102 via a management network 103 in this example. The networks may be a wired network, or all or some networks may be a wireless network.

A network topology database (not illustrated) is also connected to the management network 103, and the management network 103 is accessible from the network operation management device 102. Although the details are publicly known and thus omitted, a connection relation between the multi-service node, peripheral devices to connect, and a physical network configuration can be managed in the network topology database.

<Configuration of Multi-Service Node>

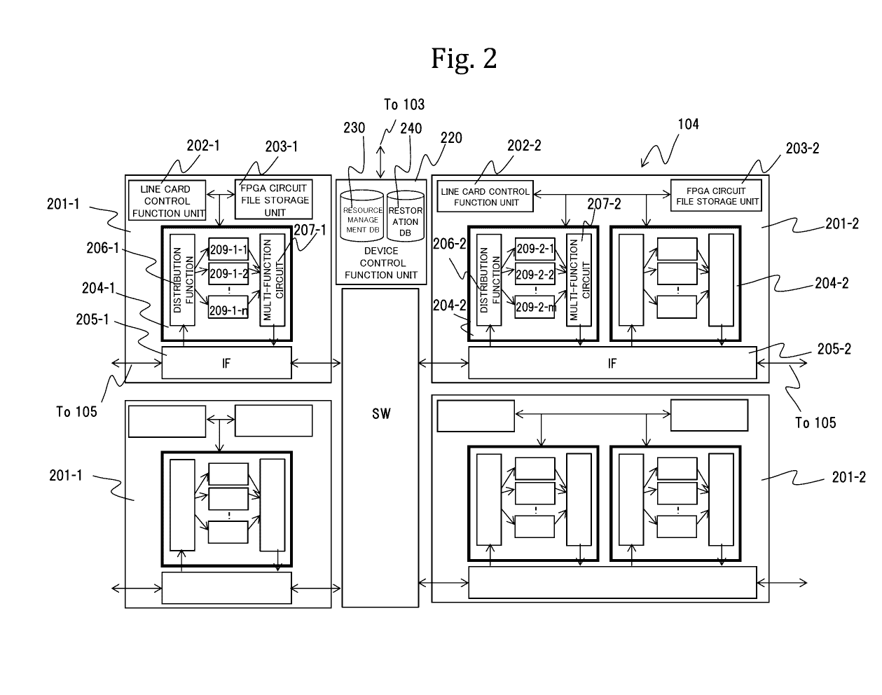

FIG. 2 is a configuration block diagram illustrating an example of the multi-service node according to an embodiment. The multi-service node 104 is a communication device that processes a packet and transfers a packet to another node. FIG. 2 illustrates an example of a shelf type multi-service node in which a plurality of line cards are mounted.

In the multi-service node 104 illustrated in FIG. 2, a plurality of line cards are connected via a switch SW. In the example of FIG. 2, two line cards 201-1 in each of which one FPGA 204-1 is mounted and two line cards 201-2 in each of which two FPGAs 204-2 are mounted are mounted.

As known in a common communication device, the line cards 201-1 and 201-2 include communication interfaces 205-1 and 205-2, respectively. A packet input from the carrier network 105 is input to the line card 201 through the communication interface 205. A packet processed and output by the line card 201 is transferred to another line card via the switch SW as necessary and released into the carrier network 105 via the communication interface 205 of the line card of a transfer destination. A detailed description of the other components with which a known node (communication device) is commonly equipped is omitted.

Here, for example, the FPGA 204-1 is assumed to be TYPE01 available from a company A, and the FPGA 204-2 is assumed to be TYPE02 available from a company B. The FPGAs 204-1 and 204-2 include distribution function circuits (modules) 206-1 and 206-2, multi-function circuits (modules) 207-1 and 207-2, core circuit 209-1-1 to 209-n and 209-2-1 to 209-m, respectively. The FPGA can have a desired circuit function as a circuit is installed according to a program file. This operation is also referred to as a “configuration.” Here, n and m are arbitrarily natural numbers indicating the number of core circuits. The distribution function circuit 206, the multi-function circuit 207, and the core circuit 209 may be configured with a circuit installed in the FPGA. A detailed description of the other components of a known FPGA is omitted.

Upon receiving an input packet from the communication interface 205, the distribution function circuit 206 identifies a packet type, clips header information of a packet, and distributes the header information to the appropriate core circuit 209 based on the packet type. As the packet identification, for example, there is a method of analyzing the inside of a packet and specifying a distribution identification ID. A type value of a MAC header can be used as the distribution identification ID. Packets that are determined to have the same type value with reference to the type values of the MAC headers of received packets are identified as packets that are subject to the same process. A physical port ID used to receive a packet can be used as the distribution identification ID. In this case, when an identification ID of a physical port at which a received packet arrives is allocated to the packet, packets that are the same in the identification ID of the physical port are identified as packets that are subject to the same process.

A priority order can be given to a packet at the time of distribution. Further, when there are a plurality of core circuits having the same function, it is possible to distribute packets to the core circuits in parallel and increase a band through a parallel process. Various kinds of known techniques can be applied as a distribution process of the distribution function circuit 206.

The distribution function circuit 206 may clip up to payload information as well as the header information and transfer the clipped information to the core circuit 209. The distribution function circuit 206 may clip a data amount of a certain size regardless an identified packet type and transfer the clipped data amount to the core circuit 209.

The core circuit 209 can perform an arbitrary packet process as a packet processing circuit is installed according to a program file. Upon receiving the header information or the like from the distribution function circuit 206, the core circuit 209 executes a different process according to each installed packet processing circuit, and transfers the header information or the like to the multi-function circuit 207.

As an example, an operation when a virtual local area network (VLAN) circuit is installed in the core circuit 209 as the packet processing circuit will be described. Upon receiving a data packet, the packet processing circuit acquires a VID (that identifies a VLAN and stores a value set for each VLAN) included in a VLAN tag of the received data packet from the data packet, and specifies the user that has transmitted the data packet based on the VID. Thereafter, the packet processing circuit specifies transfer destination of the data packet of the user, and further specifies an MPLS-TP path (a data communication path set to a WAN) for transferring the data packet. When the MPLS-TP path can be specified, the packet processing circuit generates an MPLS-TP header for transferring the data packet through the MPLS-TP path next, and capsulates the data packet.

The VLAN circuit has been described above as an example, but various kinds of applications, for example, applications having various functions including a firewall, capsulation, mobile accommodation, traffic control such as policing or coloring, evolved packet core (EPC), and a deep packet inspection (DPI) can be applied as the packet process.

The multi-function circuit 207 receives the data packets that have undergone a certain packet process through the core circuit 209, multiplexes the data packets, and transfers the multiplexed data packet to the communication interface 205 through the switch SW.

The line cards 201-1 and 201-2 further include line card control function units (line card control modules) 202-1 and 202-2 and FPGA circuit file storage units 203-1 and 203-2. The line card control function unit 202 controls installation and uninstallation of the packet processing circuit in the core circuit 209 of the FPGA 204. The line card control function unit 202 can be configured with a common micro computer that executes a predetermined command. The FPGA circuit file storage unit 203 is preferably configured with a non-volatile storage device such as a flash memory or a hard disk drive.

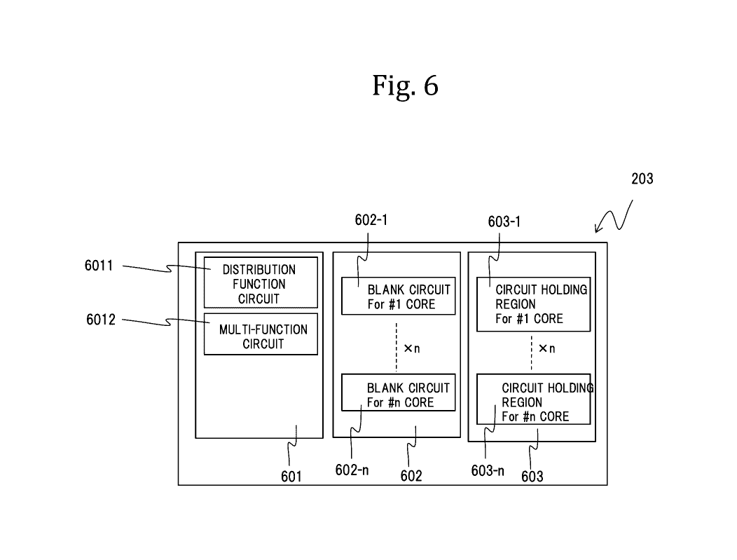

The FPGA circuit file storage unit 203 stores a program file of a packet processing circuit to be installed in the core circuit 209. The FPGA circuit file storage unit 203 will be described later in detail with reference to FIG. 6.

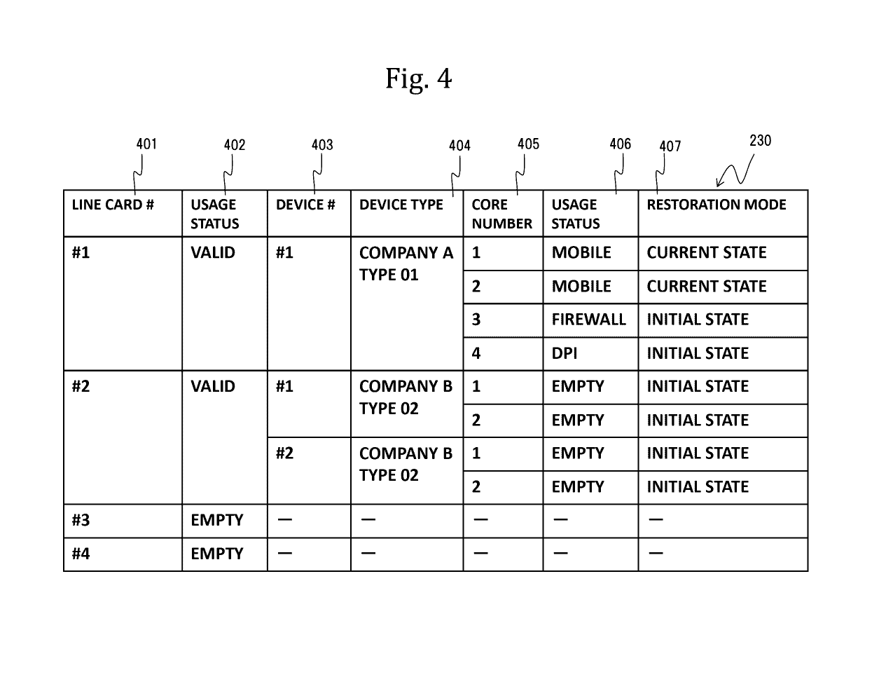

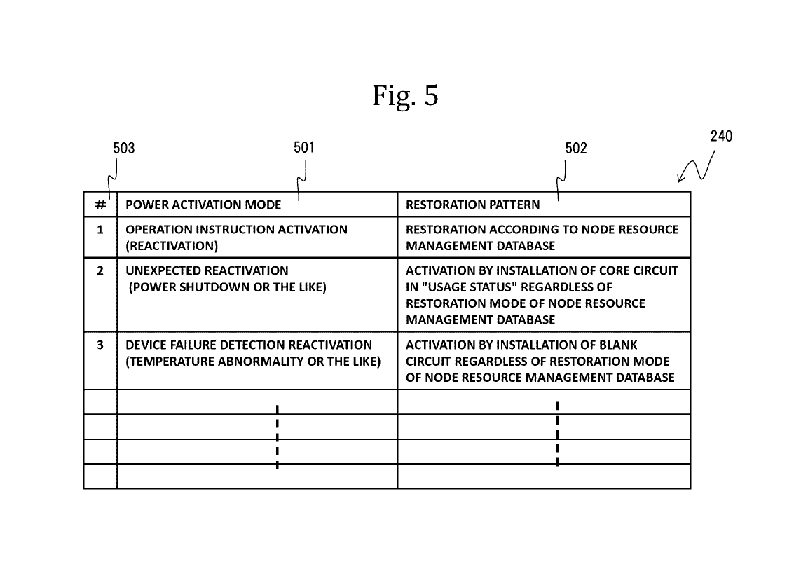

A device control function unit (device control module) 220 includes a node resource management database 230 and a restoration database 240. The device control function unit 220 is connected to the management network 103 through an internal interface (not illustrated). The device control function unit 220 can be configured with a common micro computer that executes a predetermined command. The node resource management database 230 and the restoration database 240 are preferably configured with a non-volatile storage device such as a flash memory or a hard disk drive. Content of the databases will be described later in detail with reference to FIGS. 4 and 5.

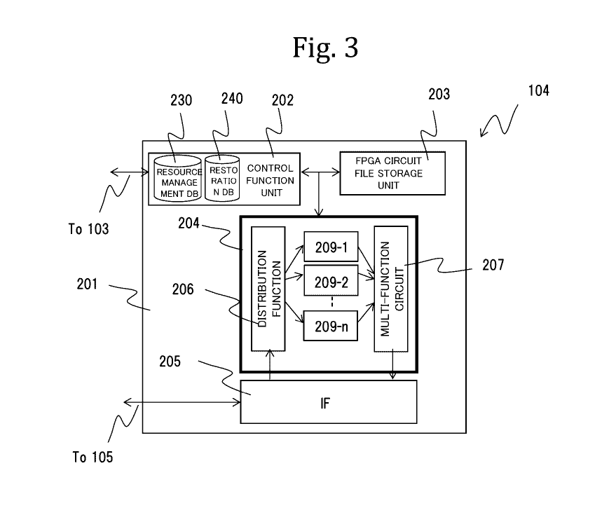

FIG. 3 is a configuration block diagram illustrating another example of the multi-service node according to an embodiment. Here, a box type multi-service node in which a single FPGA is mounted is illustrated. The same components as the components of FIG. 2 are denoted by the same reference numerals, and a description thereof is omitted. In the example of FIG. 3, a node includes one line card 201. In FIG. 3, since the number of line cards 201 is only one, the switch SW illustrated in FIG. 2 is omitted. The node resource management database 230 and the restoration database 240 shared by the entire device in FIG. 2 are arranged in the line card control function unit 202. The line card control function unit 202 is connected to the management network 103 through an internal interface (not illustrated).

<Data Held in Multi-Service Node>

FIG. 4 is a table illustrating an example of the node resource management database 230 in the multi-service node 104 according to an embodiment. The example of FIG. 4 is an example applied to the shelf type multi-service node of FIG. 2. The node resource management database 230 stores data for managing each core circuit of an FPGA belonging to a node.

The table of FIG. 4 includes an entry 401 indicating a number of a line card accommodated in a node. A usage status of each line card 201 is indicated by usage status data 402. “valid” indicates that a line card is in an activation status, and “empty” indicates a state in which no line card is mounted in a card slot or a line card is not in operation (a card is not recognized), for example, electric power is not supplied.

A device number 403 identifies the FPGA 204 with which each line card 201 is equipped. In the case of the multi-service node of FIG. 2, the line card 201-1 is equipped with one FPGA, and the line card 201-2 is equipped with two FPGAs, but, for example, a line card number 1 indicates the line card 201-1, and a line card number 2 indicates the line card 201-2. In other words, the device numbers 403 that correspond to the number of FPGAs mounted in the corresponding line card are provided in association with the line card numbers.

The line card number 401, the usage status 402, the device number 403, a device type 404, and a core number 405 can be input by an operator when the FPGA 204 is set to the line card 201. A usage status 406 and a restoration mode 407 can be recorded by control of a device as will be described later.

The device type 404 specifies, for example, a manufacturer and a type of each FPGA 204. When the packet processing circuits have the same function but differ in a manufacturer and a type, program files to be installed are different. The core number 405 identifies the core circuit 209 in which each FPGA 204 is installed. In a plurality of core circuits 209-1-1 to 209-n and 209-2-1 to 209-m with which the FPGA is equipped, as described above, even when the same circuit configuration is set, different program files are necessary for the respective core circuits. The usage status 406 indicates a packet processing circuit installed in each core circuit 209. The restoration mode 407 specifies a state to be set at the time of restoration. “Current state” indicates that a corresponding file of a use packet processing core circuit storage unit 603 (which will be described later with reference to FIG. 6) of the FPGA circuit file storage unit 203 is written at the time of restoration. “Initial state” indicates that a corresponding file of an initial setting core circuit storage unit 602 of the FPGA circuit file storage unit 203 is written at the time of restoration.

The table of FIG. 4 can be similarly applied to the box type multi-service node of FIG. 3 as well. When the table of FIG. 4 is applied to the box type multi-service node, since only one line card and one FPGA are arranged, the line card number 401 does not need data of the usage status 402 and the device number 403.

As described above, the multi-service node 104 according to the present embodiment has a function of managing a status of an FPGA of its own node.

FIG. 5 is a table illustrating an example of the restoration database 240 of the multi-service node according to an embodiment. The restoration database 240 indicates a correspondence between a situation at the time of power activation and a restoration pattern corresponding thereto.

A power activation mode 501 indicates a type of situation at the time of restoration. Examples of the type of situation at the time of restoration include activation based on an instruction given by an operator, reactivation from unexpected interruption such as power shutdown, and reactivation when interrupted as a result of detecting a device failure or the like.

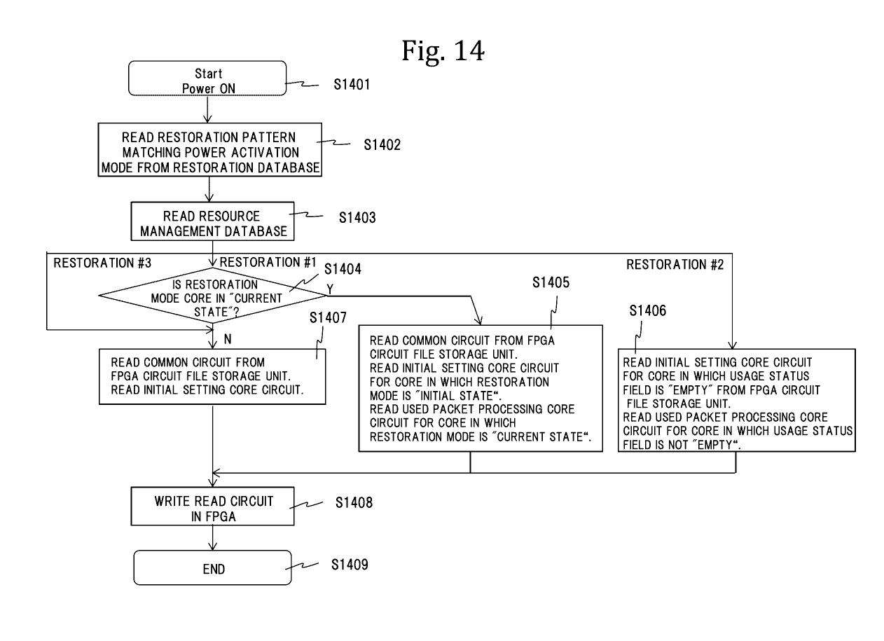

A restoration pattern 502 indicates a restoration process in association with each power activation mode 501. Examples of the restoration process include restoration according to the node resource management database, activation by installation of a packet processing circuit in “usage status” regardless of the restoration mode of the node resource management database 230, and activation by installation of a blank circuit regardless of the restoration mode of the node resource management database 230. A circuit installation process will be described later in detail with reference to FIG. 14.

For example, in the case of the activation based on the instruction given by the operator, the restoration is performed according to the restoration mode 407 that is stored in the node resource management database 230 in advance. In the case of the reactivation from the unexpected interruption such as the power shutdown, in order to restore to the original state rapidly, restoration to a state indicated by the usage status 406 of the node resource management database 230 is performed. In the case of the restoration from a state considered to be caused by a device failure such as temperature abnormality, since the abnormality is likely to continue when an operation is continued, the blank circuit is installed, and restoration to the initial state is performed.

The power activation mode 501 and the restoration pattern 502 are defined in advance and stored in the restoration database 240 of the multi-service node 104. The power activation mode 501 and the restoration pattern 502 may be appropriately delivered from the FPGA core circuit file management device 101 to each multi-service node 104 and stored in the restoration database 240.

FIG. 6 is a configuration diagram illustrating an example of data held in the FPGA circuit file storage unit 203 of the multi-service node according to an embodiment. The FPGA circuit file storage unit 203 stores the program file of the circuit to be installed in the FPGA 204 of the node or the line card. The FPGA circuit file storage unit 203 includes a common portion circuit storage unit 601, the initial setting core circuit storage unit 602, and the use packet processing core circuit storage unit 603.

The common portion circuit storage unit 601 stores a file for a common circuit that is also used by all nodes or line cards. Examples of the common circuit include a distribution function circuit 6011 and a multi-function circuit 6012.

The initial setting core circuit storage unit 602 stores an initial setting file of the core circuit 209. The initial setting file is a blank (dummy) circuit for securing a region of each core circuit. In the example of FIG. 6, blank circuits 601-1 to 601-n that correspond to the number of core circuits 209 are arranged. Here, n indicates the number of core circuits 209 managed by the initial setting core circuit storage unit 602.

Since content of the common circuit and the blank circuit is initially decided, the common portion circuit storage unit 601 and the initial setting core circuit storage unit 602 are preferably stored when the multi-service node is booted. The common portion circuit storage unit 601 and the initial setting core circuit storage unit 602 may be rewritten through the management network 103 as necessary.

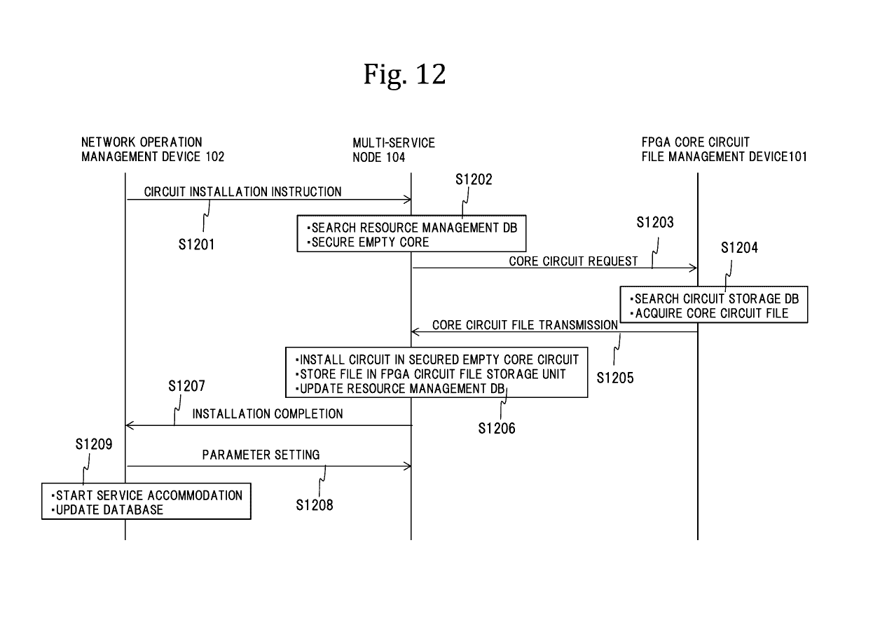

The program files of the packet processing circuits used by the core circuits 209 are stored in the use packet processing core circuit storage unit 603. To this end, core circuit holding regions 603-1 to 603-n that correspond to the number of core circuits are arranged. As the packet processing circuit used by each core circuit, an arbitrary circuit is used according to circumstances. Thus, content of the use packet processing core circuit storage unit 603 is newly registered or updated according to a sequence to be described later with reference to FIG. 12.

<Configuration of FPGA Core Circuit File Management Device>

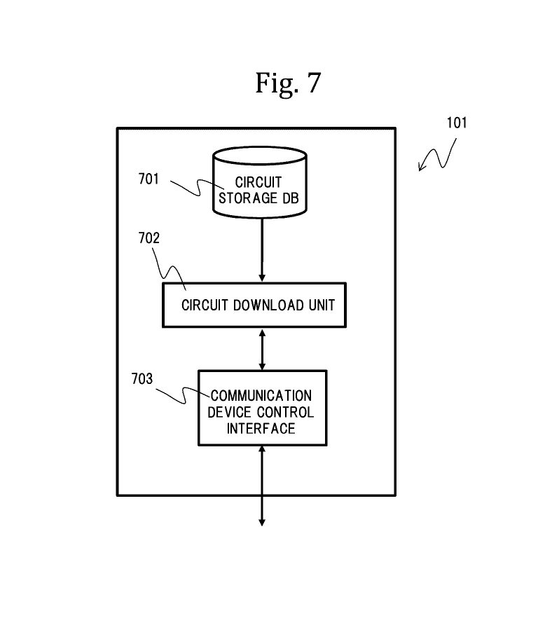

FIG. 7 is a block diagram illustrating an example of the FPGA core circuit file management device 101 according to embodiment. The FPGA core circuit file management device 101 manages and delivers the program file of the packet processing circuit installed in the core circuit 209 of the FPGA of each multi-service node 104. The FPGA core circuit file management device 101 can have a configuration of a common server including an input device, an output device, a processing device, and a storage device. A keyboard and a monitor operated by the operator may be included as the input device and the output device.

The FPGA core circuit file management device 101 includes a circuit storage database 701, a circuit download unit (circuit download module) 702, and a communication device control interface 703. The circuit storage database 701 is configured as a part of a storage device. The circuit download unit 702 is configured such that a program stored in a storage device controls hardware such as a processing device. The communication device control interface 703 is configured as a part of an input device or an output device and connected with the management network 103.

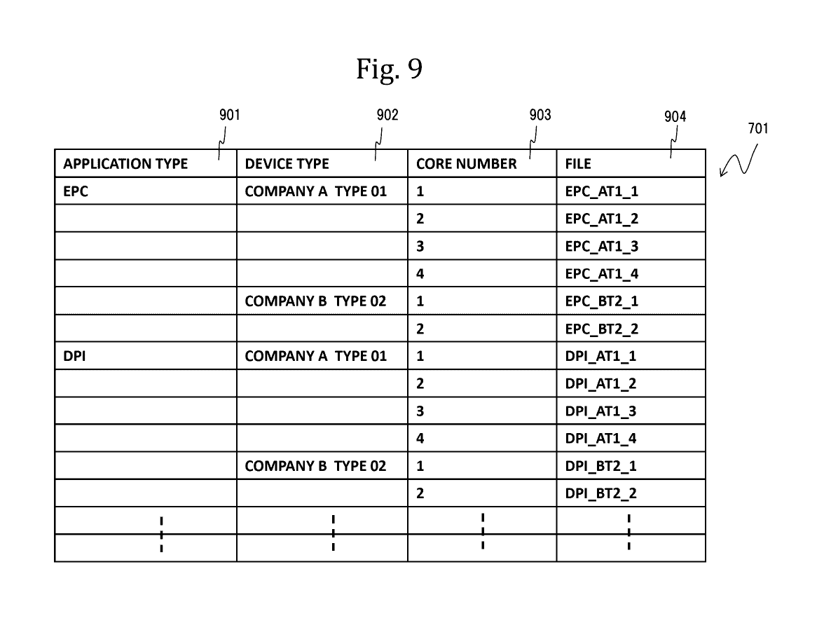

The circuit storage database 701 will be described later in detail with reference to FIG. 9. The circuit download unit 702 downloads a desired program file from the circuit storage database 701. The communication device control interface 703 delivers the downloaded program file to a desired multi-service node 104 via the management network 103.

<Configuration of Network Operation Management Device>

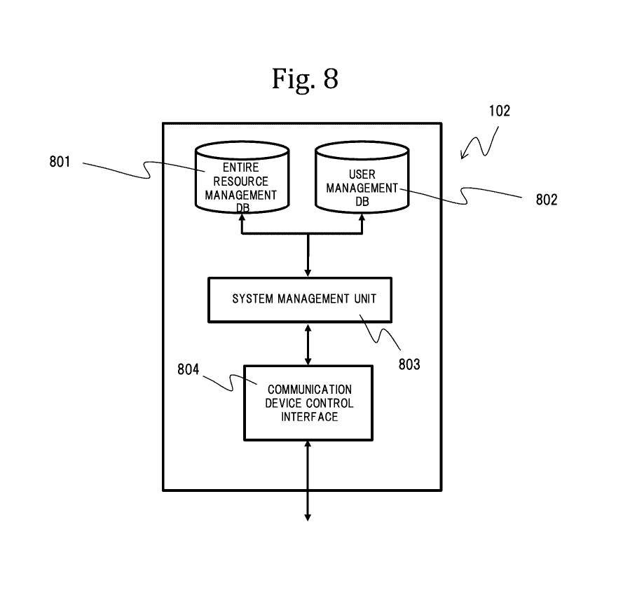

FIG. 8 is a configuration block diagram illustrating an example of the network operation management device 102 according to an embodiment. The network operation management device 102 manages resources and the users of the entire network, and controls the multi-service nodes 104.

The network operation management device 102 can have a configuration of a common server including an input device, an output device, a processing device, and a storage device. A keyboard and a monitor operated by the operator may be included as the input device and the output device.

The network operation management device 102 includes an entire resource management database 801, a user management database 802, a system management unit 803, and a communication device control interface 804. The entire resource management database 801 and the user management database 802 are configured as a part of a storage device. The system management unit (system management module) 803 is configured such that a program stored in a storage device controls hardware such as a processing device. The communication device control interface 804 is configured as a part of an input device or an output device.

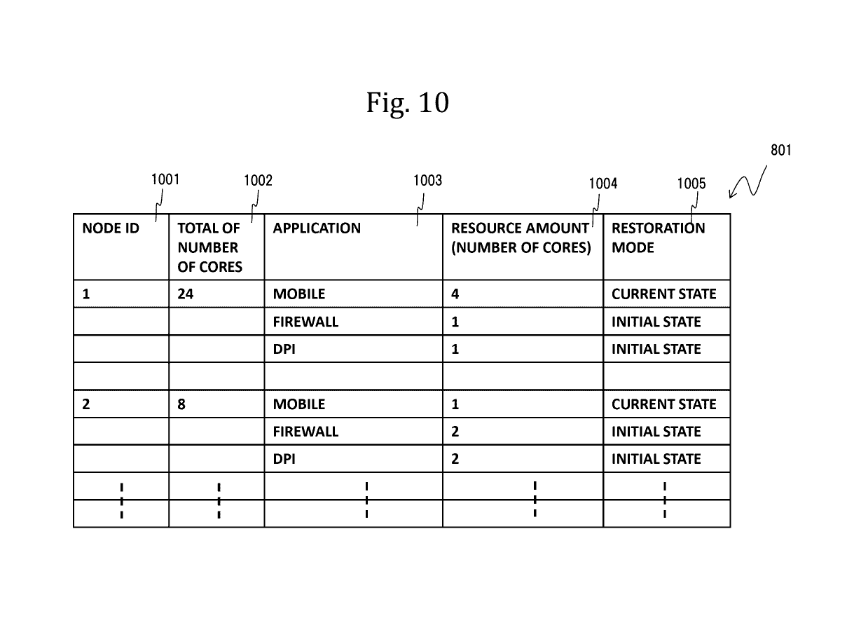

The entire resource management database 801 and the user management database 802 will be described later in detail with reference to FIG. 10. The system management unit 803 controls the entire network operation management device 102, and generates a control command to be given to the multi-service node 104. The communication device control interface 804 delivers the control command received from the system management unit 803 to a desired multi-service node 104 via the management network 103.

<Data Held in FPGA Core Circuit File Management Device>

FIG. 9 is a table illustrating an example of the circuit storage database 701 with which the FPGA core circuit file management device 101 according to an embodiment is equipped. The circuit storage database 701 classifies and stores a program file for installing an application assumed to be used in a network system in the core circuit 209. Ideally, the packet processing circuits applicable to all the core circuits of all types of FPGAs assumed to be used are covered. The circuit storage database 701 is assumed to be constructed by a network system administrator.

In the circuit storage database 701, a device type 902, a core number 903 of a corresponding device, and a program file 904 to be applied to a core circuit having a corresponding core number are stored in association with an application type 901 of the packet processing circuit.

There may not be an available program file due to a reason such as a specification of a device depending on a combination of the device type, the core number, and the application type. In this case, in the circuit storage database 701 illustrated in FIG. 9, information such as “not applicable (n/a)” is preferably stored as the file 904 in association with the device type and the core number.

<Data Held in Network Operation Management Device>

FIG. 10 is a table illustrating an example of the entire resource management database 801 with which the network operation management device 102 according to an embodiment is equipped. The entire resource management database 801 manages the usage status of the core circuit with which each multi-service node 104 belonging to the system is equipped. Data of the network operation management device 102 is appropriately updated based on information transmitted from the multi-service nodes 104.

A node ID 1001 is an identifier uniquely identifying each multi-service node 104. A total of the number of cores 1002 indicates the number of core circuits belonging to each multi-service node 104. An application 1003 indicates a type of packet processing circuit installed in each multi-service node 104. A resource amount 1004 indicates a resource amount (the number of core circuits) used for each application. A restoration mode 1005 indicates a restoration mode set to each application.

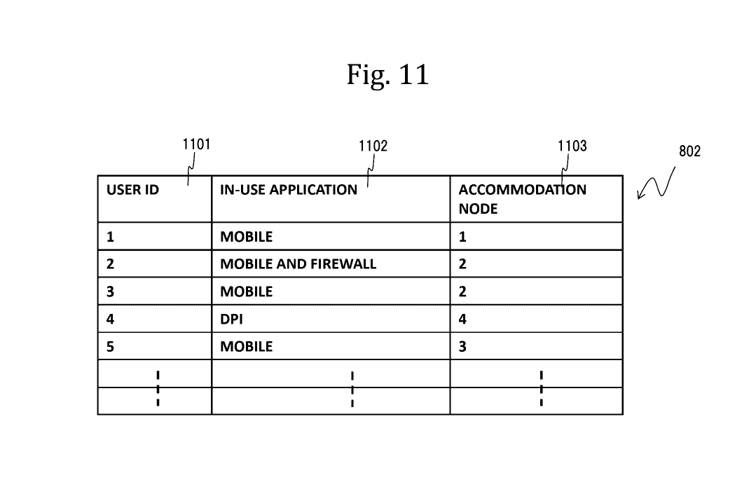

FIG. 11 is a table illustrating an example of the user management database 802 with which the network operation management device 102 according to an embodiment is equipped. The user management database 802 manages a relation between the multi-service node 104 in which an application is accommodated and the accommodated application for each user 106. A user ID 1101 is an identifier uniquely identifying each user 106. An in-use application 1102 indicates a type of application being used by the user. An accommodation node 1103 indicates the multi-service node 104 in which a corresponding application is accommodated.

<Installation Process>

Next, the flow of a process of installing an arbitrary packet processing circuit in the core circuit of the FPGA of the multi-service node 104 according to the present embodiment will be described.

FIG. 12 is a flowchart illustrating an example of a circuit installation sequence according to an embodiment.

First, the system management unit 803 of the network operation management device 102 gives an instruction to install a predetermined packet processing circuit to a predetermined multi-service node 104 (step S1201). The instruction is transmitted from the communication device control interface 804 of the network operation management device 102 to the multi-service node 104 through the management network 103. The multi-service node 104 receives the instruction through a predetermined interface. Hereinafter, transmission of the instruction from the network operation management device 102 to the multi-service node 104 is similarly performed.

Examples of information included in the circuit installation instruction include an “application type,” the “number of core circuits to be used,” and a “restoration mode.” The application type indicates a type of packet processing circuit to be installed. The number of core circuits to be used indicates the number of core circuits in which the packet circuit is installed.

By installing the same packet circuit in a plurality of core circuits, distributing packets through the distribute circuit, and performing the parallel process, the processing speed is improved, and the band is increased. For example, here, packet process performance of one packet processing circuit is assumed to be 10 Gbit/sec, and the same packet processing function (here, an MPLS-TP protocol processing function) is assumed to be installed in three core circuits. At this time, due to the parallel process, a multi-service node has the packet process performance of MPLS-TP data of 30 Gbit/sec.

The restoration mode defines the state of the core circuit at the time of reactivation. Examples of the restoration mode include “current state” for restoring to a state immediately before interruption at the time of restoration after the power shutdown and “initial state” for restoring to a blank state.

For example, the instruction to install the packet processing circuit can be given by the operator inputting a command to the network operation management device 102 when it is necessary to newly install the packet processing circuit in the multi-service node 104. It is necessary to newly install the packet processing circuit in the multi-service node 104, for example, when a new user 106 is added, when the existing user 106 requests a new service, when a new multi-service node 104 is added, when the band or function of the multi-service node 104 is increased, or the like.

When the installation instruction is given, it is desirable that there is an empty core in a target multi-service node 104. The state of the empty core can be checked based on a difference between the total of the number of cores 1002 and the resource amount 1004 with reference to the entire resource management database 801 (FIG. 10). At this time, content of the entire resource management database 801 illustrated in FIG. 10 may be displayed to the operator so that the operator selects a target node ID 1001 to be installed.

The multi-service node 104 that gives the installation instruction needs to be set to a communication path used by the user who uses an application. The setting can be performed with reference to information of the network topology database. A node having no empty core circuit 209 can be removed from a choice with reference to the entire resource management database 801 (FIG. 10).

The following description will proceed with the multi-service node having the configuration of FIG. 2. In the multi-service node 104 that has received the instruction, the line card control function unit 202 or the device control function unit 220 is assumed to perform a process according to control of software but may perform a process according to dedicated hardware.

When there are a plurality of processing devices inside or outside the multi-service node, the process can be shared and performed by the plurality of processing devices. For example, when there are the line card control function unit 202 and the device control function unit 220, an arbitrary portion of a process performed by the line card control function unit 202 may be performed by the device control function unit 220, or vice versa. The same applies in the following description. Further, when there is no device control function unit 220 as in the configuration of FIG. 3, it goes without saying that the line card control function unit 202 performs control.

In the multi-service node 104 that has received the instruction, the line card control function unit 202 searches the node resource management database 230 (FIG. 4), and secures an available core circuit (step S1202).

For example, in the example of the node resource management database 230 of FIG. 4, a total of four core circuits, that is, the core numbers 1 and 2 of the device number 1 of the line card number 2 and the core numbers 1 and 2 of the device number 2 of the line card number 2 are understood to be empty as the available core circuit. Here, for example, when the circuit installation instruction designates 2 (two) as the number of core circuits, two arbitrary core circuits or two core circuits according to a predetermined condition (for example, the descending order of the numbers) are secured from the four core circuits. Further, when there is no space corresponding to the requested number of core circuits, it is desirable to transmit an error signal to the network operation management device 102.

Then, the device control function unit 220 of the multi-service node 104 transmits a core circuit request to the FPGA core circuit file management device 101 (step S1203). The request is transmitted from the predetermined interface of the multi-service node 104 to the FPGA core circuit file management device 101 via the management network 103. Hereinafter, transmission from the multi-service node 104 to the FPGA core circuit file management device 101 is similarly performed.

Examples of information included in the core circuit request include the “application type” included in the circuit installation instruction of step S1201 and the “device type” and the “core number” secured in step S1202. For example, the “device type” secured in step S1202 is TYPE02 available from the company B, and the “core number” is the numbers 1 and 2 in the example of the node resource management database of FIG. 4, the information is transmitted to the FPGA core circuit file management device 101.

The FPGA core circuit file management device 101 that has received the core circuit request searches the circuit storage database 701 (FIG. 9), and acquires a program file corresponding to the core circuit request through the circuit download unit 702 (step S1204). For example, when the core circuit request designates the EPC as the “application type,” designates TYPE02 available from the company B as the “device type,” and the numbers 1 and 2 as the “core number,” two files “EPC_BT2_1” and “EPC_BT2_2” of FIG. 9 are downloaded.

When the program file corresponding to the requested core circuit request is not found, it is desirable to transmit an error signal to the network operation management device 102 through the multi-service node 104 or directly.

The program file downloaded from the circuit storage database 701 in step S1204 is transmitted from the communication device control interface 703 to the multi-service node 104 via the management network 103 (step S1205). Hereinafter, transmission from the FPGA core circuit file management device 101 to the multi-service node 104 is similarly performed.

The multi-service node 104 that has received the program file installs the received program file in the secured empty core circuit according to control of the line card control function unit 202 (step S1206). When the “core number” 1 and 2 of TYPE02 available from the company B in the node resource management database 230 of FIG. 4 are secured as described above, and the files “EPC_BT2_1” and “EPC_BT2_2” are received, the packet processing circuit having the application function of the EPC is installed in the core circuits. An installation method may be the same as that of a known FPGA.

The line card control function unit 202 stores the received program file in the FPGA circuit file storage unit 203 (FIG. 6). Regions that correspond to the number of core circuits 209 in the line card 201 are secured in the use packet processing core circuit storage unit 603 of the FPGA circuit file storage unit 203. Then, the received program file is stored in the use packet processing core circuit storage unit 603. At this time, it is desirable that the respective regions of the use packet processing core circuit storage unit 603 be managed in association with the respective core circuits.

The line card control function unit 202 or the device control function unit 220 updates the node resource management database 230 (FIG. 4). In the node resource management database 230, the state of the core circuit in which the packet processing circuit is newly installed is changed from “empty” to “current state.” For example, when the files “EPC_BT2_1” and “EPC_BT2_2” serving as the EPC application are installed in the “core numbers” 1 and 2 of TYPE02 available from the company B in the node resource management database 230 of FIG. 4, the usage status 406 of the corresponding item of FIG. 4 is changed from “empty” to “EPC.” Further, the restoration mode 407 is changed from “initial state” to “current state” according to the circuit installation instruction.

After the installation in the core circuit of the packet processing circuit is completed, the line card control function unit 202 or the device control function unit 220 of the multi-service node 104 transmits an installation completion notification to the network operation management device 102 via the management network 103 (step S1207).

The network operation management device 102 performs a known process for accommodating a service such as a process of setting a parameter of the multi-service node 104 (step S1208).

The network operation management device 102 updates the entire resource management database 801 and the user management database 802. In the entire resource management database 801, the application 1003, the resource amount 1004, and the restoration mode 1005 is newly registered or updated for the node ID 1001 of the multi-service node 104 in which the packet processing circuit is newly installed. In the user management database 802, the user ID 1101, the in-use application 1102, and the accommodation node 1103 are newly registered or updated for the user to which a new application is applied. Thereafter, service accommodation starts (step S1209).

According to the above process, the multi-service node 104 can store only a program file that is needed by its own node, and thus a memory capacity can be saved. Further, the multi-service node 104 can request the FPGA core circuit file management device 101 to transmit a program file that is needed by its own node. Thus, the multi-service node 104 can easily acquire and install a packet processing circuit having a desired function, and thus complexity in program file management can be prevented.

<Uninstallation Process>

Next, the flow of a process of uninstalling an arbitrary packet processing circuit from the core circuit of the FPGA of the multi-service node 104 according to the present embodiment will be described.

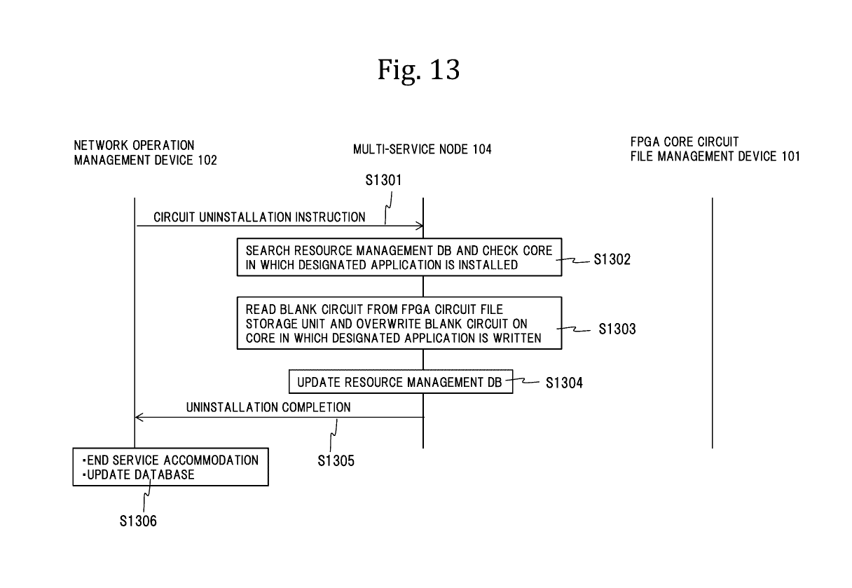

FIG. 13 is a flowchart illustrating an example of a circuit uninstallation sequence according to an embodiment. First, the system management unit 803 of the network operation management device 102 gives an instruction to uninstall a predetermined packet processing circuit to a predetermined multi-service node 104 (step S1301).

Examples of information included in the circuit uninstallation instruction include an “application type,” the “number of core circuits to be deleted,” and a “restoration mode.” The application type indicates a type of packet processing circuit to be uninstalled. The number of core circuits to be deleted indicates the number of core circuits from which a packet circuit is uninstalled. When the same packet circuit is installed in a plurality of core circuits, the band is increased by distributing packets through the distribute circuit, but when the packet circuit is uninstalled from some core circuits, the band can be changed (reduced). The “restoration mode” may not be designated and may be set to “initial state” by default.

The instruction to uninstall the packet processing circuit may be given by the operator inputting a command to the network operation management device 102, for example, when it is necessary to uninstall the packet processing circuit of the multi-service node 104. It is necessary to uninstall the multi-service node 104, for example, when the user 106 is deleted, when a service to the existing user 106 is stopped, when the multi-service node 104 is discarded, when the band or function of the multi-service node 104 is reduced, or the like.

The multi-service node 104 that gives the uninstallation instruction may be selected from the multi-service nodes 104 corresponding to the node ID 1001 of a node in which a predetermined application 1003 is accommodated with reference to the entire resource management database 801 (FIG. 10). At this time, content of the entire resource management database 801 illustrated in FIG. 10 is preferably displayed to the operator so that the operator selects the application 1003 a target node ID 1001 to be uninstalled.

The multi-service node 104 that has received the instruction executes the process through the device control function unit 220 or the line card control function unit 202. The line card control function unit 202 or the like searches the node resource management database 230 (FIG. 4), and checks a core in which a designated application is installed (step S1302). When it is difficult to check the core in which the designated application is installed, the multi-service node 104 may transmit a response of not applicable” to the network operation management device 102.

When the core in which the designated application is installed is checked, the line card control function unit 202 reads the blank circuit 601 from the FPGA circuit file storage unit 203 (FIG. 6), and overwrite the read blank circuit 601 on the core circuit in which the designated is written (step S1303). At this time, since a blank circuit to be applied differs according to each core number even in the same FPGA product, a corresponding blank circuit is used. By overwriting the blank circuit, a region for installing a packet processing circuit later is secured.

Thereafter, the node resource management database 230 (FIG. 4) is updated, and the usage status of the core circuit is updated to the latest status (step 1304).

The above process will be described using a specific example. In the state of the node resource management database 230 of FIG. 4, in step S1301, the circuit uninstallation instruction is assumed to designate “mobile” as the “application type,” and designates 2 (two) as the number of core circuits to be deleted.” In this case, in step S1302, it is possible to check that “mobile” is installed in the core numbers 1 and 2 of the device #1. Then, in step S1303, the blank circuits corresponding to the core numbers 1 and 2 of the device #1 are read from the initial setting core circuit storage unit 602 of the FPGA circuit file storage unit 203 and overwritten on the core circuits. Thereafter, in step S1304, in the node resource management database 230 of FIG. 4, the usage status 406 corresponding to the core numbers 1 and 2 of the device #1 is changed from “mobile” to “empty,” and the restoration mode 407 is changed from “current state” to “initial state.”

After step S1304 is completed, the multi-service node 104 transmits an uninstallation completion notification to the network operation management device 102 (step S1305). The network operation management device 102 that has received the uninstallation completion notification updates the entire resource management database 801 (FIG. 10) and the user management database 802 (FIG. 11). In the entire resource management database 801, the application 1003, the resource amount 1004, and the restoration mode 1005 are deleted or updated for the node ID 1001 of the multi-service node 104 from which the packet processing circuit is uninstalled. In the user management database 802, the user ID 1101, the in-use application 1102, and the accommodation node 1103 are deleted or updated for the user from which the application is uninstalled. The service accommodation ends (step S1306).

As described above, in the present embodiment, it is possible to install or uninstall the packet processing function in or from the multi-service node 104 flexibly. As a result, it is possible to implement optimization of a resource cost of a communication service provider, easily communication service accommodation replacement, and a reduction in an operation load. Further, by installing the blank circuit, it is possible to secure a necessary region of the core circuit with a high degree of certainty.

<Activation Process>

FIG. 14 is a flowchart illustrating an example of a device activation process according to an embodiment. The process starts from a state in which reactivation (or first activation) is performed after electric power of the multi-service node 104 is interrupted due to a certain reason (step S1401). For example, this may be executed by a reactivation program stored in a non-volatile memory of the multi-service node 104. A subsequent process is assumed to be performed by the line card control function unit 202 or the line card control function unit 202 and the device control function unit 220 of the multi-service node 104 according to control of software but may be performed by dedicated hardware. Hereinafter, the description will proceed with the multi-service node 104 having the configuration of FIG. 3.

When the process starts, the device control function unit 220 searches the restoration database 240 (FIG. 5), selects the power activation mode 501 matching the state at the time of power activation, and reads the restoration pattern 502 corresponding to the selected power activation mode 501 (step S1402). Further, content of the node resource management database 230 (FIG. 4) is read (step S1403). Step S1402 and S1403 may be performed in the opposite order or may be performed in parallel.

After step S1403, bifurcation is performed according to the restoration pattern 502 read (selected) in step S1402. For the sake of description of FIG. 14, the selected restoration pattern 502 is indicated by a number 503 in FIG. 5.

When the restoration pattern #1 is selected, the restoration is performed according to the node resource management database 230. The device control function unit 220 searches the node resource management database 230, and checks the presence or absence of the core circuit in which the restoration mode 407 is “current state” (step S1404). When there is a core circuit in which the restoration mode 407 is “current state,” a program file installed in the core circuit of the corresponding core number is read from the use packet processing core circuit storage unit 603 of the FPGA circuit file storage unit 203 (FIG. 6). Further, when there is a core circuit in which the restoration mode 407 is “initial state,” a blank circuit file for the core circuit of the corresponding core number is read from the initial setting core circuit storage unit 602 of the FPGA circuit file storage unit 203. The distribution function circuit 6011 and the multi-function circuit 6012 are read from the common portion circuit storage unit 601 of the FPGA circuit file storage unit 203 (step S1405). When there is no core circuit in which the restoration mode 407 is “current state,” the process proceeds to step S1407.

When the restoration pattern #2 is selected, the restoration is performed according to the usage status 406 regardless of the restoration mode 407 of the node resource management database 230. The device control function unit 220 searches the node resource management database 230, and when there is a core circuit in which the usage status 406 is “empty,” a blank circuit file for the core circuit of the corresponding core number is read from the initial setting core circuit storage unit 602 of the FPGA circuit file storage unit 203. Further, when there is a core circuit in which the usage status 406 is not “empty,” a program file installed in the core circuit of the corresponding core number is read from the use packet processing core circuit storage unit 603. The distribution function circuit 6011 and the multi-function circuit 6012 are read from the common portion circuit storage unit 601 of the FPGA circuit file storage unit 203 (step S1406).

When the restoration pattern #3 is selected, it returns to the initial state regardless of the restoration mode 407 of the node resource management database 230. The device control function unit 220 reads the blank circuit files for all the core circuits from the initial setting core circuit storage unit 602 of the FPGA circuit file storage unit 203. The distribution function circuit 6011 and the multi-function circuit 6012 is read from the common portion circuit storage unit 601 of the FPGA circuit file storage unit 203 (step S1407). In the case of the restoration pattern #3, the process (step S1403) of reading the node resource management database 230 may be omitted.

In step S1408, the read program file is installed in the corresponding core circuit 209 of the FPGA circuit 204, and the process ends (step S1409).

According to the present embodiment described above, it is possible to reset the core circuit of the FPGA in the appropriate state according to the status at the time of reactivation.

### Second Embodiment

In the first embodiment, the FPGA is assumed to be arranged in the communication device (node) to process the communication packet. However, the concept of the present invention is not limited thereto, and it is possible to perform various kinds of processes on data other than the communication packet in an FPGA in an information processing device (for example, a server) outside the communication device. In other words, data processed by the FPGA is not limited to a packet flowing on a network and may be data stored in a storage device of a server.

In this case, a system configuration may be, for example, a configuration in which the carrier network 105 and the network operation management device 102 are omitted from the system of FIG. 1. Further, a server connected to the FPGA core circuit file management device 101 via the management network 103 is used instead of the multi-service node 104.

For example, the system has a configuration in which the communication interface 205 connected with the carrier network 105 is omitted from the configuration of FIG. 3, and data to be processed is input to the FPGA 204, for example, from a storage device such as a hard disk (not illustrated). The data input to the FPGA 204 is processed by the function installed in the core circuit 209 and then output. In this case, the distribution function circuit 206 and the multi-function circuit 207 of FIG. 3 are not necessarily required.

Processes of installing and uninstalling the core circuit in the FPGA through the server may be performed similarly to the first embodiment. However, when the network operation management device 102 is omitted, the network operation management device 102 is omitted from the flow of the processes of FIGS. 12 and 13, and the installation and the uninstallation start by autonomous control of the server installed instead of the multi-service node 104.

In such a server, for example, it is possible to install a function of performing various kinds of processes such as compression, decompression, and processing on image data stored in the storage device in the core circuit of the FPGA. For example, in the case of image compression, there are various kinds of schemes according to various standards. When a compression scheme is added or changed for the image data stored in the storage device, the server requests the FPGA core circuit file management device 101 to provide a necessary program file via the management network 103. The request includes information specifying a necessary data processing function (for example, a predetermined compression scheme), information specifying a device type of an FPGA, and information specifying a core number of a core circuit in an FPGA. In response to the request, the server installs the received program file in the core circuit of the FPGA. Further, it is possible to uninstall an unnecessary function.

The present invention is not limited to the above-described embodiments, and includes various modifications and equivalents configurations within the gist of the appended claims.

For example, the above embodiments are the detailed description for facilitating understanding of the present invention, and the present invention is not limited to a configuration necessarily having all components described above. Some components of a certain embodiment may be replaced with components of another embodiment. Components of another embodiment may be added to components of a certain embodiment. Further, addition, deletion, or replacement of other components may be performed on some components of each embodiment. Furthermore, all or some of the components, the functions, the processing units, the processing means, or the like described above may be implemented by hardware, for example, by designing them using an integrated circuit or may be implemented by software by interpreting and executing a program for implementing the functions through a processor.

Control lines or information lines indicate one considered to be necessary for a description, and all control lines or information lines necessary for implementation are not necessarily illustrated. Practically, most components may be considered to be connected to one another.

What is claimed is:

1. A communication system, comprising:
a plurality of nodes; and
a file management server,
wherein each of the nodes includes a plurality of packet processing modules to which a packet processing function is settable through a program file,
each of the nodes transmits a request including information specifying the packet processing function to be set and the packet processing module to the file management server, and sets the packet processing function based on information received in response to the request,
the file management server includes a circuit storage database that holds a plurality of different program files which are settable to the packet processing module, and
the file management server selects the program file based on the request, and transmits the selected program file to the node serving as a transmission source of the request.

2. The communication system according to claim 1, further comprising,
an operation management server that manages the plurality of nodes,
wherein the operation management server transmits an installation instruction including information specifying the packet processing function to be set to an arbitrary node among the plurality of nodes,
the node includes a node resource management database that manages usage statuses of the plurality of packet processing modules, and
the node searches the node resource management database based on the installation instruction, selects the packet processing module to which the packet processing function is settable, and transmits the request including information specifying the selected packet processing module to the file management server.

3. The communication system according to claim 2,
wherein the plurality of packet processing modules are a plurality of core circuits of a field-programmable gate array (FPGA), and
the information specifying the packet processing module is a device type of the FPGA and a core number of the core circuit.

4. The communication system according to claim 3,
wherein the installation instruction includes information designating the number of core circuits to which the packet processing function is set.

5. The communication system according to claim 3,
wherein the installation instruction includes information designating a setting of the core circuit at a time of activation of the node.

6. The communication system according to claim 3,
wherein the operation management server transmits an uninstallation instruction including information specifying the packet processing function whose setting is released to an arbitrary node among the plurality of nodes, and
the node searches the node resource management database based on the uninstallation instruction, selects the packet processing module in which a setting of the packet processing function is releasable, and overwrites a blank circuit on the selected packet processing module through a program that is held in advance.

7. The communication system according to claim 6,
wherein the uninstallation instruction includes information designating the number of core circuits in which the setting of the packet processing function is released.

8. A communication device, comprising:
a field-programmable gate array (FPGA) that includes a plurality of core circuits to which a packet processing function is settable through a program file, and processes packets received from a network through the core circuits;
an FPGA circuit file storage unit that stores the program file; and
a control unit that sets the packet processing function to the core circuits,
wherein a request including information specifying the packet processing function to be set and the core circuit is transmitted to a file management server, and the packet processing function is set based on a program file received in response to the request, and
the received program file is stored in the FPGA circuit file storage unit.

9. The communication device according to claim 8,
wherein the FPGA circuit file storage unit includes
a use packet processing core circuit storage unit including a plurality of core circuit holding regions arranged in association with the core circuits in the communication device to store the received program file, and
an initial setting core circuit storage unit including a plurality of blank circuit holding regions arranged in association with the core circuits in the communication device to store blank circuits securing regions of the core circuits.

10. The communication device according to claim 9,
wherein the FPGA circuit file storage unit further includes a common portion circuit storage unit that stores a program file for at least one of a distribution function circuit and a multi-function circuit.

11. The communication device according to claim 8,
wherein the request includes information specifying a device type of the FPGA and information specifying a core number of the core circuit in the FPGA as information specifying the core circuit.

12. The communication device according to claim 11, further comprising,
a node resource management database,
wherein the node resource management database stores the packet processing function set to the core circuit as a usage status in association with the information specifying the core circuit.

13. A data processing device, comprising:
a field-programmable gate array (FPGA) that includes a plurality of core circuits to which a data processing function is settable through a program file, and processes input data through the core circuits;
an FPGA circuit file storage unit that stores the program file; and
a control unit that sets the data processing function to the core circuits,
wherein a request including information specifying the data processing function to be set and the core circuit is transmitted to a file management server, and the data processing function is set based on a program file received in response to the request, and
the received program file is stored in the FPGA circuit file storage unit.

14. The data processing device according to claim 13,
wherein the FPGA circuit file storage unit includes
a use data processing core circuit storage unit including a plurality of core circuit holding regions arranged in association with the core circuits in the communication device to store the received program file, and
an initial setting core circuit storage unit including a plurality of blank circuit holding regions arranged in association with the core circuits in the communication device to store blank circuits securing regions of the core circuits.

15. The data processing device according to claim 13,
wherein the request includes information specifying a device type of the FPGA and information specifying a core number of the core circuit in the FPGA as information specifying the core circuit.
